(19) United States
(12) Patent Application Publication
(10) Pub. No.: US 2026/0352343 A1
(43) Pub. Date: Nov. 5, 2026

(54) SCRAMBLE CIRCUIT, COMMUNICATION SYSTEM, AND SCRAMBLE METHOD

(71) Applicant: NTT Innovative Devices Corporation, Yokohama-shi, Kanagawa (JP)

(72) Inventors: Masahiro ORIMO, Kanagawa (JP); Takahiro HATA, Kanagawa (JP)

(73) Assignee: NTT Innovative Devices Corporation, Yokohama-shi, Kanagawa (JP)

(21) Appl. No.: 19/485,693

(22) PCT Filed: Jun. 5, 2024
(86) PCT No.: PCT/JP2024/020538

§ 371 Date: Nov. 19, 2025

(30) Foreign Application Priority Data
Jun. 19, 2023 (JP) 2023-100187

(51) Int. Cl. H04B 10/69; H03K 19/23; H04B 10/50

(52) U.S. Cl. CPC H04B 10/69; H03K 19/23; H04B 10/50

(57) ABSTRACT

A scramble circuit continuously scrambling a series of data includes: k provisional scramble circuits dividing the series of data into groups of L (L is a natural number) data pieces, grouping k (k is a natural number) groups to make one data set of L×k data pieces, performing scrambling processing in k lines in parallel; k pattern generation circuits generating output data from only initial values without receiving the series of data; and k EXOR circuits each calculating an exclusive OR of each pair of respective data pieces at same place in order with regard to outputs of the k provisional scramble circuits and outputs of the k pattern generation circuits, and outputting continuous scrambled data for the L×k data pieces.

### FIELD

The present disclosure relates to a scramble circuit, a communication system, and a scramble method.

### BACKGROUND

A scramble circuit is used in a communication system (for example, see PTL 1).

### CITATION LIST

### Patent Literature

[PTL 1] JP 2006-324921 A

### SUMMARY OF THE INVENTION

### Problem to Be Solved by the Invention

There has been a problem that while data rates are getting higher in recent years, the operations of conventional scramble circuits cannot respond thereto.

The present disclosure has been made to solve the problem as described above, and an objective thereof is to attain a scramble circuit, a communication system, and a scramble method that can reduce a processing period for scrambling.

### Solution to Problem

A scramble circuit according to the present disclosure continuously scrambling a series of data includes: k provisional scramble circuits dividing the series of data into groups of L (L is a natural number) data pieces, grouping k (k is a natural number) groups to make one data set of L×k data pieces, performing scrambling processing in k lines in parallel; k pattern generation circuits generating output data from only an initial value without receiving the series of data; and k EXOR circuits each calculating an exclusive OR of each pair of respective data pieces at same place in order with regard to outputs of the k provisional scramble circuits and outputs of the k pattern generation circuits, and outputting continuous scrambled data for the L×k data pieces, wherein part of output of the (i−1)-th EXOR circuit is set as an initial value of an i-th (i is a natural number equal to or more than two and equal to or less than k) pattern generation circuit of the k pattern generation circuits.

### Advantageous Effects of Invention

In the present disclosure, since scrambling processing is performed in parallel, the number of stages in serial processing can be reduced. Thus, since the processing period for scrambling can be reduced, it is possible to respond to cases where the data rate increases.

### BRIEF DESCRIPTION OF THE DRAWINGS

FIG. 1 shows a communication system according to an embodiment 1.

FIG. 2 shows the general-purpose scramble circuit.

FIG. 3 is a diagram of the general-purpose scramble circuit broken down into the provisional scramble circuit and the pattern generation circuit.

FIG. 4 shows outputs of a general-purpose scramble circuit and outputs of the scramble circuit in FIG. 3.

FIG. 5 shows outputs of the scramble circuit in FIG. 3 when the initial values of the provisional scramble circuit are set to zero.

FIG. 6 is a diagram of the scramble circuit in FIG. 3 changed to a 2-parallel processing configuration.

FIG. 7 shows outputs of the scramble circuit in FIG. 6.

FIG. 8 shows the scramble circuit according to the embodiment 1.

FIG. 9 shows the scheme by which 2-parallel processing of data in the first set is performed by the scramble circuit according to the embodiment 1.

FIG. 10 shows the scheme by which 2-parallel processing of data in the second set is performed by the scramble circuit according to the embodiment 1.

FIG. 11 shows the scheme by which k-parallel processing of data in an m-th set is performed by the scramble circuit according to the embodiment 1.

FIG. 12 shows the scheme by which k-parallel processing of data in the (m+1)-th set is performed by the scramble circuit according to the embodiment 1.

FIG. 13 shows a scramble circuit according to an embodiment 2.

FIG. 14 shows an example in which a three-stage linear-feedback shift register is applied to the sub-scramble circuit in the embodiment 2.

FIG. 15 shows outputs of the scramble circuit in FIG. 14.

FIG. 16 shows a scramble circuit according to the comparison example.

FIG. 17 shows an example in which a 58-stage linear-feedback shift register is applied to the sub-scramble circuit in the embodiment 2.

FIG. 18 shows an output of the scramble circuit in FIG. 17.

FIG. 19 shows an output of the scramble circuit in FIG. 17.

FIG. 20 shows an example in which a 58-stage linear-feedback shift register is applied to the sub-scramble circuit in the embodiment 2, and the number of sub-scramble stages is eight.

FIG. 21 shows operations performed by the scramble circuit in FIG. 20.

### DESCRIPTION OF EMBODIMENTS

A scramble circuit, a communication system, and a scramble method according to the embodiments of the present disclosure will be described with reference to the drawings. The same components will be denoted by the same symbols, and the repeated description thereof may be omitted.

### Embodiment 1

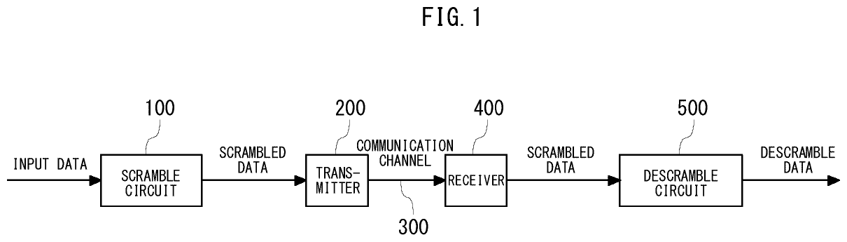

FIG. 1 shows a communication system according to an embodiment 1. When the same data continues, it is difficult to obtain a bit timing on a receiving side. To solve such a problem, a scramble circuit 100 continuously scrambles a series of data on a transmitting side. A transmitter 200 transmits the scrambled data outputted from the scramble circuit 100 to a communication channel 300 of fiber optics or the like. A receiver 400 receives the scrambled data from the communication channel 300 and decodes the scrambled data. A descramble circuit 500 descrambles the scrambled data outputted from the receiver 400 and recovers the original data.

Next, before the scramble circuit according to the present embodiment is described, it is described that a general-purpose scramble circuit can be broken down into a provisional scramble circuit and a pattern generation circuit.

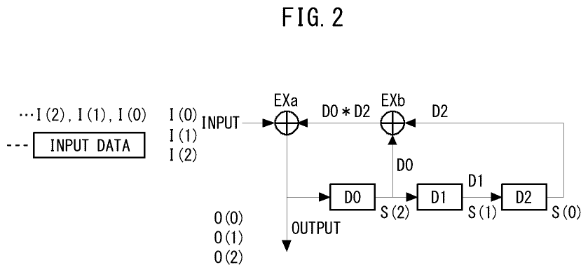

FIG. 2 shows the general-purpose scramble circuit. The general-purpose scramble circuit is a linear-feedback shift register and includes three-stage shift registers D0, D1, D2 and EXOR circuits EXa, EXb. S(n) is an initial value of each register (n=0, 1, 2). The general-purpose scramble circuit receives serial data I(0), I(1), I(2) as input sequentially, performs scrambling, and outputs O(0), O(1), O(2) sequentially.

An exclusive OR of output of the first-stage shift register D0 and output of the third-stage shift register D2 is calculated, and an exclusive OR of a result of the operation and the input data is calculated and is fed back, as input, to the first-stage shift register D0. A feedback polynomial for the above-described general-purpose scramble circuit can be expressed as 1+X+X\hat{ }3.

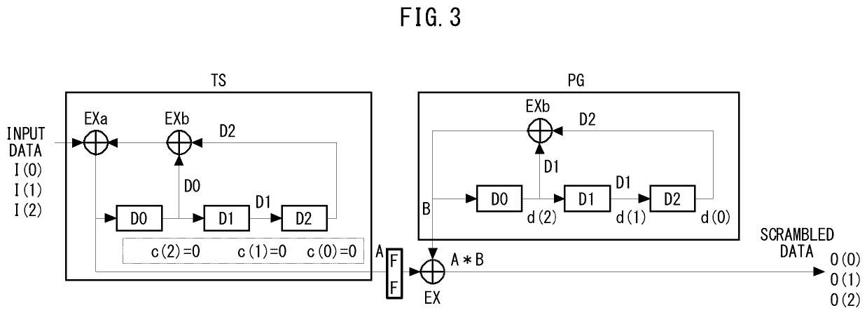

FIG. 3 is a diagram of the general-purpose scramble circuit broken down into the provisional scramble circuit and the pattern generation circuit. The general-purpose scramble circuit in FIG. 2 can be broken down into the provisional scramble circuit TS, which receives data as input and performs scrambling processing, and the pattern generation circuit PG, which generates output data from only initial values without receiving data as input. The pattern generation circuit PG is a linear-feedback shift register having the same number of stages as the provisional scramble circuit TS. Output A of the provisional scramble circuit TS is retained by a flip-flop circuit FF. An EXOR circuit EX calculates an exclusive OR of the output A of the provisional scramble circuit TS and output B of the pattern generation circuit PG, and outputs the exclusive OR as scrambled output.

c(n) is an initial value (n=0, 1, 2) of each register of the provisional scramble circuit TS. d(n) is an initial value (n=0, 1, 2) of each register of the pattern generation circuit PG. It is assumed that “*” indicates an exclusive OR in the present description, and that the initial value S(n) of each register of the general-purpose scramble circuit is S(n)=c(n)*d(n).

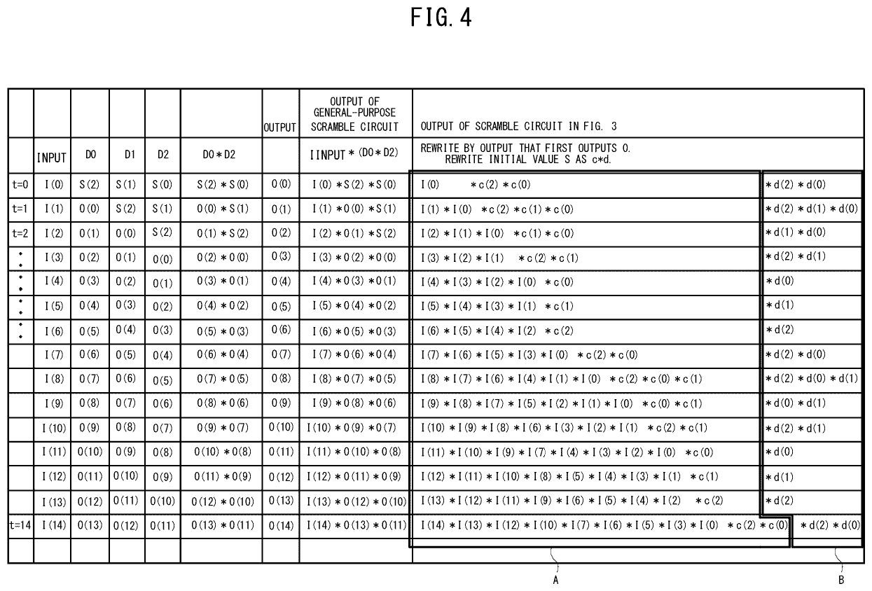

FIG. 4 shows outputs of a general-purpose scramble circuit and outputs of the scramble circuit in FIG. 3. At time t=0, when it is assumed that an input is I(0) and outputs of the shift registers D0, D1, D2 are S(2), S(1), S(0), respectively, an output O(0) of the general-purpose scramble circuit is expressed as “I(0)*S(2)*S(0)”. When the general-purpose scramble circuit is broken down into the provisional scramble circuit TS and the pattern generation circuit PG, since S(2)=c(2)*d(2) and S(0)=c(0)*d(0), the output O(0) is expressed as I(0)*c(2)*d(2)*c(0)*d(0)=(I(0)*c(2)*c(0))*(d(2)*d(0)). Expressions are similarly made also at time t=N. Accordingly, the scrambled output O(0) of the general-purpose scramble circuit in FIG. 2 can be expressed by the exclusive OR of the output A of the provisional scramble circuit TS and the output B of the pattern generation circuit PG in FIG. 3. Accordingly, the general-purpose scramble circuit can be broken down into the provisional scramble circuit TS and the pattern generation circuit PG.

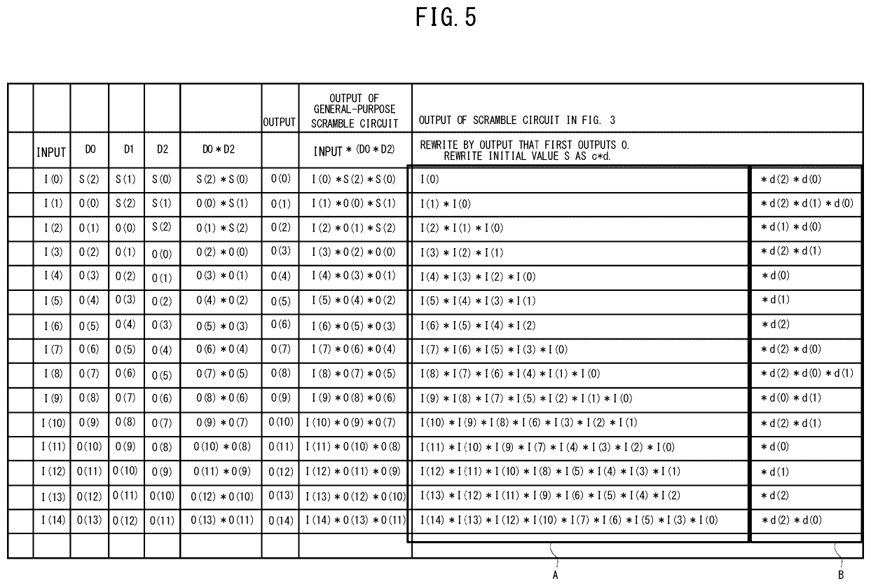

FIG. 5 shows outputs of the scramble circuit in FIG. 3 when the initial values of the provisional scramble circuit are set to zero. When the initial values of the provisional scramble circuit TS are set to zero (c(2)=c(1)=c(0)=0), the output A of the provisional scramble circuit TS can be calculated from only the input data I(n). Accordingly, calculation by the provisional scramble circuit TS can be performed easily. The output B of the pattern generation circuit PG can be calculated from only the initial values d(0) to d(2).

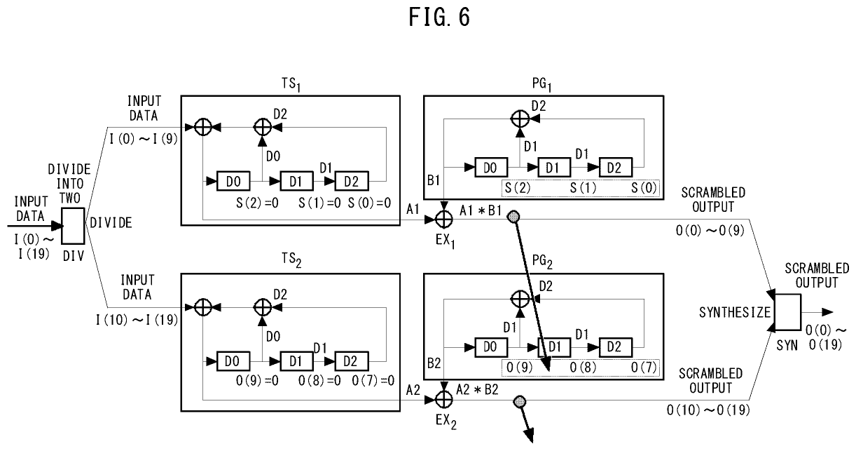

Next, it is described that the scramble circuit broken down into the provisional scramble circuit and the pattern generation circuit can be changed to a parallel processing configuration. FIG. 6 is a diagram of the scramble circuit in FIG. 3 changed to a 2-parallel processing configuration. Two sets of a provisional scramble circuit and a pattern generation circuit are prepared. A divider DIV divides input data into two, each including a predetermined number L=10 data pieces. Among input data pieces I(0) to I(19), first 10 data pieces I(0) to I(9) are inputted into an upper-side provisional scramble circuit TS₁, and next 10 data pieces I(10) to I(19) are inputted into a lower-side provisional scramble circuit TS₂. An upper-side EXOR circuit EX₁ calculates an exclusive OR of provisional output A1 of the provisional scramble circuit TS₁ and output B1 of a pattern generation circuit PG₁. A lower-side EXOR circuit EX₂ calculates an exclusive OR of provisional output A2 of the provisional scramble circuit TS₂ and output B2 of a pattern generation circuit PG₂. A synthesizer SYN synthesizes the output of the upper-side EXOR circuit EX₁ and the output of the lower-side EXOR circuit EX₂ and outputs scrambled outputs O(17) to O(19).

The last outputs O(7) to O(9) of the upper-side EXOR circuit EX₁ are set as the initial values of the lower-side pattern generation circuit PG₂. Thus, the scrambled outputs of the lower side can be a result of scrambling continuing from the scrambled outputs of the upper side.

For a following data set of I(20) to I(39), similarly, first 10 data pieces I(20) to I(29) are inputted into the upper-side circuit, and next 10 data pieces I(30) to I(39) are inputted into the lower-side circuit. However, the last outputs O(17) to O(19) of the lower-side EXOR circuit EX₂ for the previous set are set as the initial values of the upper-side pattern generation circuit PG₁. Last outputs O(27) to O(29) of the upper-side EXOR circuit EX₁ are set as the initial values of the lower-side pattern generation circuit PG₂.

As described above, with the 2-parallel processing configuration, the scramble circuit in FIG. 6 performs scrambling processing by 2L=20 data pieces at a time. Thus, the processing period can be reduced, compared to the scramble circuit in FIG. 3.

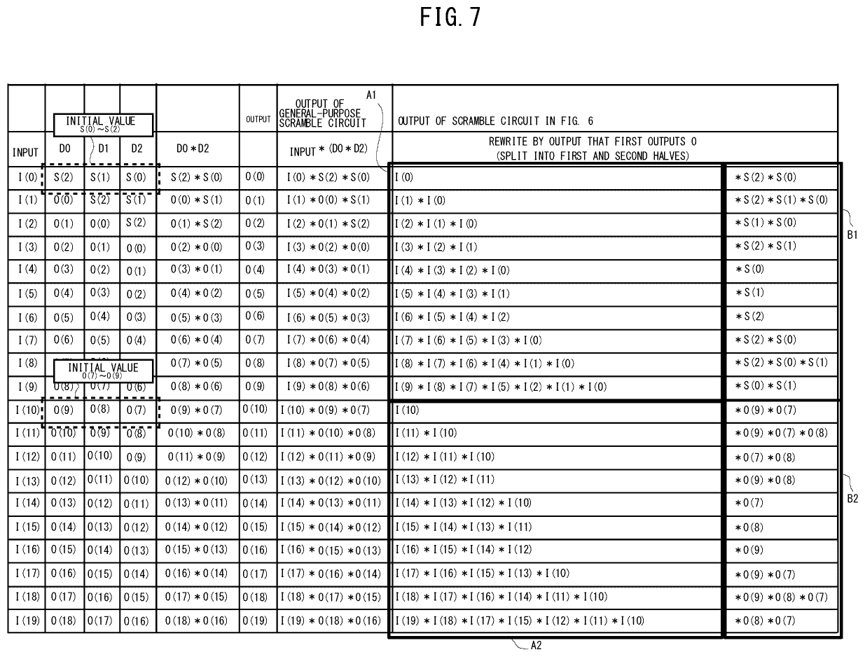

FIG. 7 shows outputs of the scramble circuit in FIG. 6. As input data, 20 data pieces I(0) to I(19) are inputted into the scramble circuit in FIG. 6. Outputs O(0) to O(9) for the inputs I(0) to I(9) can be expressed by an exclusive OR of the output A1 of the upper-side provisional scramble circuit TS₁, which is calculated from only the inputs I(0) to I(9), and the output B1 of the upper-side pattern generation circuit PG₁, which is calculated from only the initial values S(0) to S(2).

Outputs O(10) to O(19) for the inputs I(10) to I(19) can be expressed by an exclusive OR of the output A2 of the lower-side provisional scramble circuit TS₂, which is calculated from only the inputs I(10) to I(19), and the output B2 of the lower-side pattern generation circuit PG₂, which is calculated from only the outputs O(7) to O(9) of the upper-side EXOR circuit EX₁. Note that B2 is output of the pattern generation circuit PG₂ when the initial values are set to O(7) to O(9).

The above-mentioned A1 and A2 can be simultaneously calculated in parallel, for the inputs I(0) to I(9) and the inputs I(10) to I(19), respectively. B1 can be calculated instantaneously from only S(0) to S(2) that are preset as the initial values of the upper-side pattern generation circuit PG₁. B2 can be calculated instantaneously upon the outputs O(7) to O(9) being calculated by the upper-side circuit. Accordingly, the scrambled outputs O(0) to O(19) for the 20 input data pieces I(0) to I(19) can be calculated in parallel. Thus, the processing period for scrambling can be reduced. Note that scrambled outputs O(20) to O(39) for following I(20) to I(39) can also be calculated similarly.

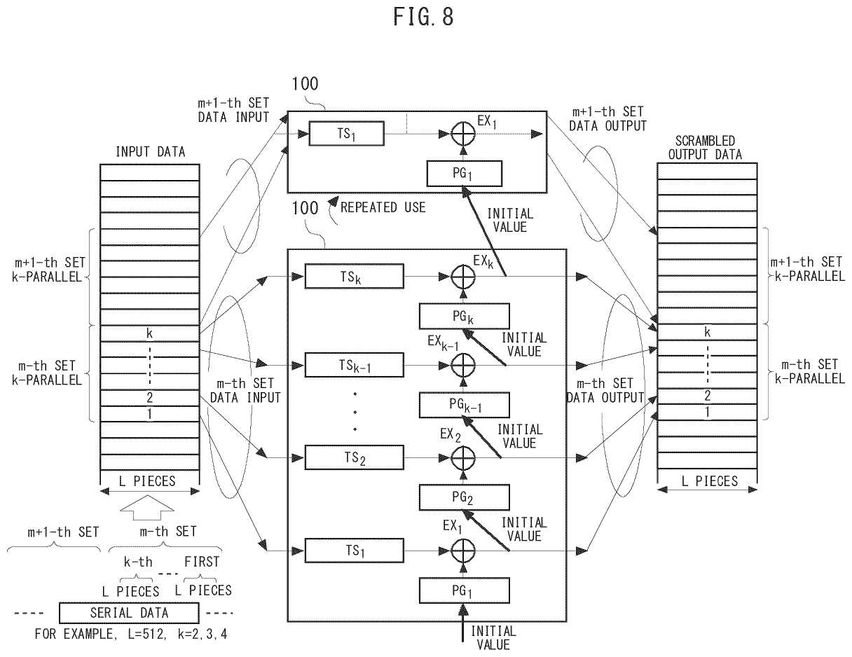

FIG. 8 shows the scramble circuit according to the embodiment 1. Input data is a series of serial data. The series of data is divided into groups of L (a natural number) data pieces. k (a natural number) groups are grouped to make one data set of L×k data pieces. For example, L is 512. Note that although not shown in FIG. 8, the divider DIV in FIG. 6 is used to divide the input data.

The scramble circuit 100 is a parallel processing scramble circuit including k provisional scramble circuits TS₁ to TSₖ that are parallel to each other, k pattern generation circuits PG₁ to PGₖ corresponding thereto, respectively, and k EXOR circuits EX₁ to EXₖ. Each of the provisional scramble circuits TS₁ to TSₖ is a linear-feedback shift register. Each of the pattern generation circuits PG₁ to PGₖ is a linear-feedback shift register having the same number of stages as the provisional scramble circuit TS₁ to TSₖ. Note that although not shown in FIG. 8, flip-flop circuits FF are inserted between the provisional scramble circuits TS₁ to TSₖ and the corresponding EXOR circuits EX₁ to EXₖ as shown in FIG. 3.

The k provisional scramble circuits TS₁ to TSₖ perform scrambling processing in k lines in parallel, handling L×k data pieces as one data set, and output L×k scrambled data pieces. In other words, each of the provisional scramble circuits TS₁ to TSₖ performs scrambling processing of L data pieces and outputs L scrambled data pieces. The pattern generation circuits PG₁ to PGₖ generate output data from only the initial values, without receiving the series of data as input.

With regard to the outputs of the k provisional scramble circuits TS₁ to TSₖ and the outputs of the k pattern generation circuits PG₁ to PGₖ, the k EXOR circuits EX₁ to EXₖ each calculate an exclusive OR of each pair of respective data pieces at the same place in order, and outputs continuous scrambled data for the L×k data pieces. For example, the first EXOR circuit EX₁ calculates an exclusive OR of each pair of data pieces at the same place in order in the output of the first provisional scramble circuit TS₁ and the output of the first pattern generation circuit PG₁. The scrambled data outputted from the EXOR circuits EX₁ to EXₖ is synthesized, and scrambled output is outputted. Note that although not shown in FIG. 8, the synthesizer SYN in FIG. 6 is used to synthesize the scrambled data.

All of the initial values of the k provisional scramble circuits TS₁ to TSₖ are fixed to zero or one. As the initial value of an i-th (i is a natural number equal to or more than two and equal to or less than k) pattern generation circuit PGᵢ of the k pattern generation circuits PG₁ to PGₖ, part of output of the (i−1)-th EXOR circuit EXᵢ₋₁ is set. When the number of stages in each of the pattern generation circuits PG₁ to PGₖ is N (N is a natural number), N data pieces counting from the last data piece of the output of the (i−1)-th EXOR circuit EXᵢ₋₁ are set as the initial values of the i-th pattern generation circuit PGᵢ. For the initial values of the first pattern generation circuit PG₁, part of output of the k-th provisional scramble circuit TSₖ for the immediately previous data set is set when the data set exists, and all zeros are set when the immediately previous data set does not exist.

Specifically, first L data pieces of the first (m=1) set are scrambled by the first provisional scramble circuit TS₁, and an exclusive OR of output thereof and output of the first pattern generation circuit PG₁ is calculated. The initial values of the first pattern generation circuit PG₁ are zero. Next L data pieces of the first set are scrambled by the second provisional scramble circuit TS₂, and an exclusive OR of output thereof and output of the second pattern generation circuit PG₂ is calculated. The last part of the output of the first EXOR circuit EX₁ is set as the initial values of the second pattern generation circuit PG₂. Similarly, k-th L data pieces of the first set are scrambled by the k-th provisional scramble circuit TSₖ, and an exclusive OR of output thereof and output of the k-th pattern generation circuit PGₖ is calculated. The last part of output of the (k−1)-th EXOR circuit EXₖ₋₁ is set as the initial values of the k-th pattern generation circuit PGₖ. Note that the initial values of all the provisional scramble circuits TS₁ to TSₖ are zero.

Subsequently, first L data pieces of the second (m=2) set are scrambled by the first provisional scramble circuit TS₁, and an exclusive OR of output thereof and output of the first pattern generation circuit PG₁ is calculated. The last part of the output of the k-th EXOR circuit EXₖ for the first set is set as the initial values of the first pattern generation circuit PG₁. Next L data pieces of the second set are scrambled by the second provisional scramble circuit TS₂, and an exclusive OR of output thereof and output of the second pattern generation circuit PG₂ is calculated. The last part of the output of the first EXOR circuit EX₁ is set as the initial values of the second pattern generation circuit PG₂. Thereafter, processing is similar to that for the first set.

A result of parallel processing of k groups of L data pieces in one data set by the above-described scramble circuit is the same as a result of continuously performing scrambling processing of serial data that is serialized L pieces×k groups of data. For the next data set, similarly, L data pieces undergo k-parallel processing. A result thereof is the same as a result of continuously performing scrambling processing of serial data that is serialized L pieces×k groups of data in the previous set and L pieces×k groups of data in the current set.

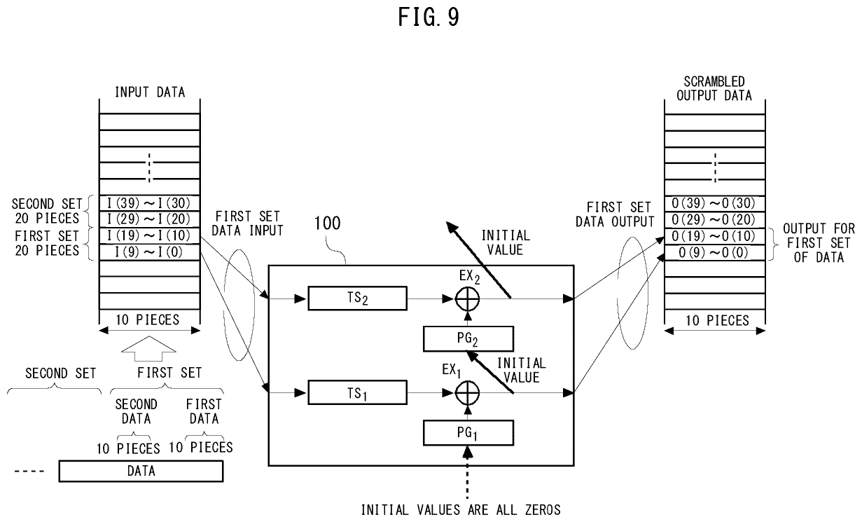

Next, a scheme for performing 2-parallel scrambling processing of input data in a continuous manner by using the scramble circuit according to the embodiment 1 is described. FIG. 9 shows the scheme by which 2-parallel processing of data in the first set is performed by the scramble circuit according to the embodiment 1. Of input data, 20 data pieces are handled as one data set. Of the data pieces in the first set, the first half, 10 I(0) to I(9), is inputted into the first provisional scramble circuit TS₁, and the second half, 10 I(10) to I(19), is inputted into the second provisional scramble circuit TS₂, at the same time. The initial values of the provisional scramble circuits TS₁, TS₂ are set to all zeros, the initial values of the first pattern generation circuit PG₁ is set to all zeros, and the last part of output of the first EXOR circuit EX₁ is set as the initial values of the second pattern generation circuit PG₂.

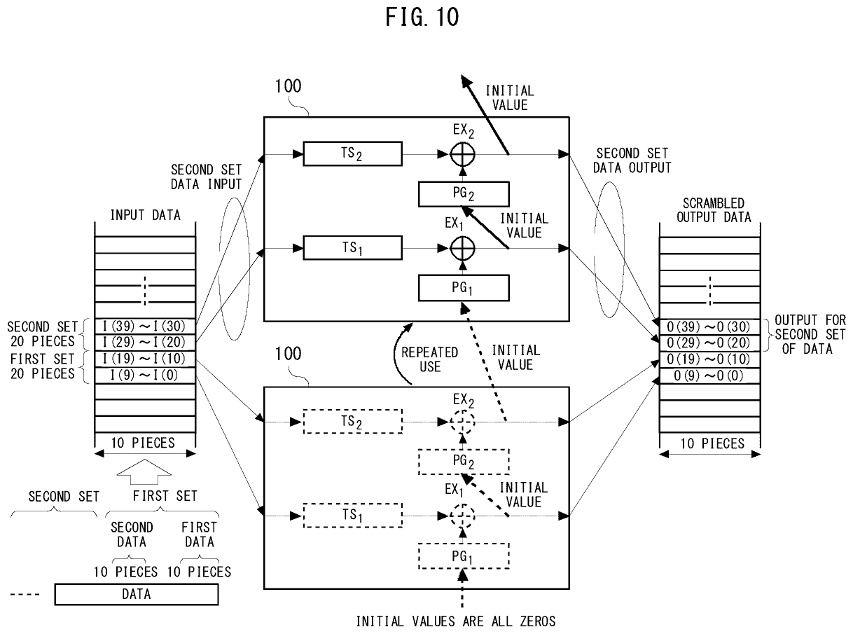

FIG. 10 shows the scheme by which 2-parallel processing of data in the second set is performed by the scramble circuit according to the embodiment 1. Of the 20 data pieces in the second set, the first half, 10 I(20) to I(29), and the second half, 10 I(30) to I(39), are inputted into the first provisional scramble circuit TS₁ and the second provisional scramble circuit TS₂ of the same scramble circuit 100, respectively, at the same time. The initial values of the provisional scramble circuits TS₁, TS₂ are all zeros. The last part of output of the second EXOR circuit EX₂ for the first set is set as the initial values of the first pattern generation circuit PG₁. The last part of output of the first EXOR circuit EX₁ is set as the initial values of the second pattern generation circuit PG₂. For following sets, calculation is performed through the similar scheme.

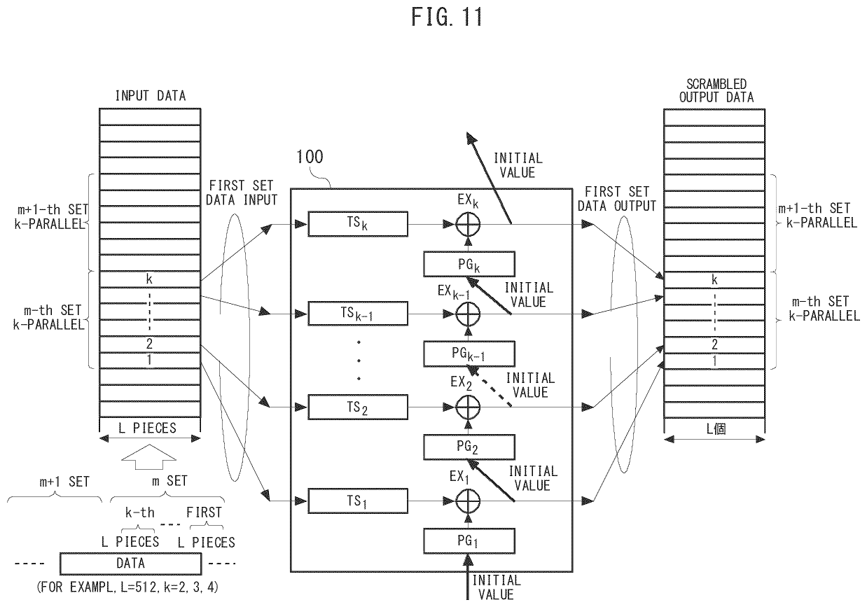

Although the scheme for 2-parallel processing has been described using FIGS. 9 and 10, a scheme generalized for k-parallel processing is described hereinafter. FIG. 11 shows the scheme by which k-parallel processing of data in an m-th set is performed by the scramble circuit according to the embodiment 1. The scramble circuit 100 performs k-parallel processing of L pieces×k groups of data in the m-th set.

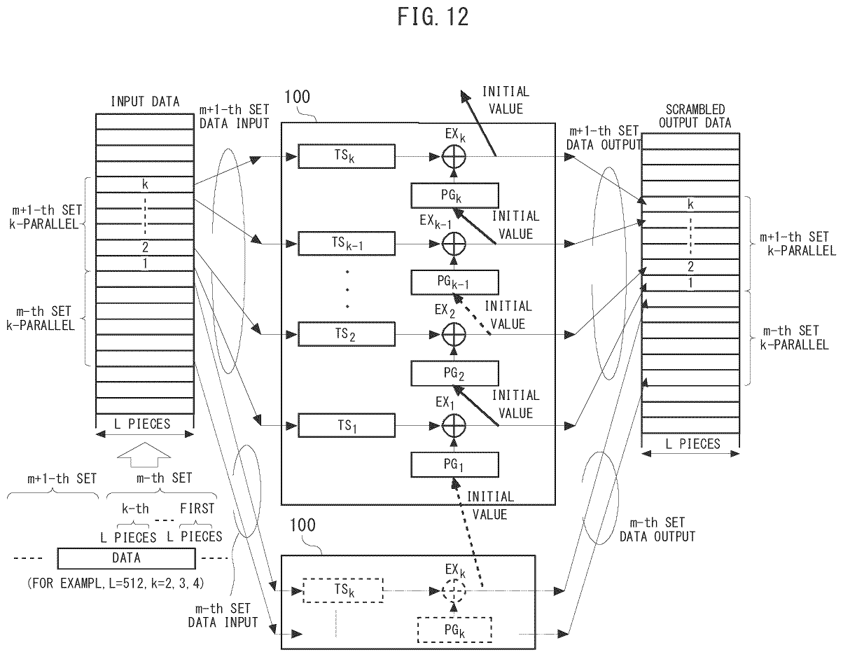

FIG. 12 shows the scheme by which k-parallel processing of data in the (m+1)-th set is performed by the scramble circuit according to the embodiment 1. The scramble circuit 100 performs k-parallel processing of the data in the (m+1)-th set, following the data in the m-th set. The last part of output of the k-th EXOR circuit EXₖ for the m-th set is set as the initial values of the first pattern generation circuit PG₁. By performing k-parallel processing as described above, the processing period for scrambling input data can be reduced to 1/k.

Next, effects of the present embodiment are described in comparison with a general-purpose scramble circuit. In the general-purpose scramble circuit, when the first input I(0) is inputted, the first output O(0) is outputted. Accordingly, when a predetermined number of data pieces are to be scrambled, a processing period proportionate to the predetermined number is required. Accordingly, when the data rate increases, the operation of the scramble circuit cannot respond thereto. In contrast, since scrambling processing is performed in parallel in the present embodiment, the number of stages in serial processing can be reduced. Thus, since the processing period for scrambling can be reduced, it is possible to respond to cases where the data rate increases.

### Embodiment 2

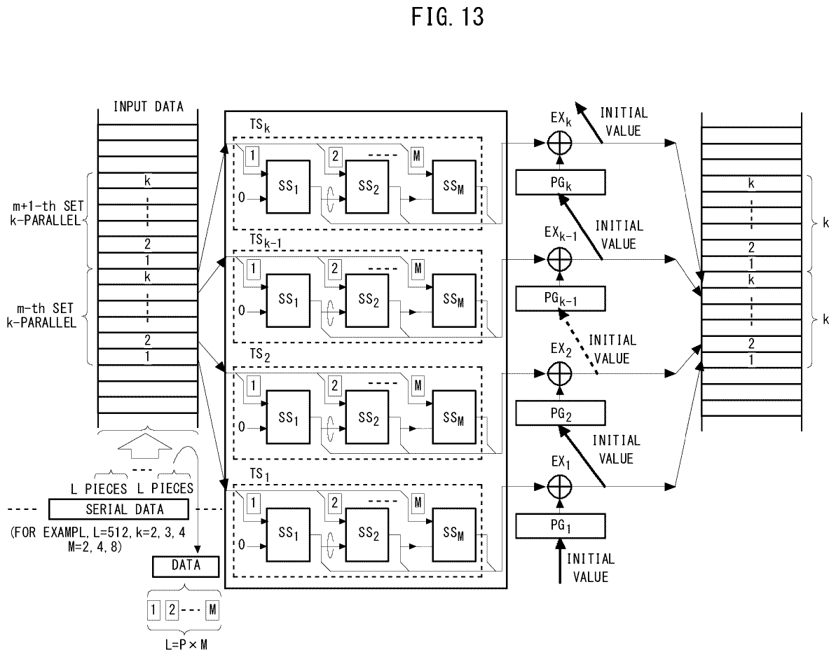

FIG. 13 shows a scramble circuit according to an embodiment 2. In the present embodiment, each of k provisional scramble circuits TS₁ to TSₖ includes M (M is a natural number) sub-scramble circuits SS₁ to SS_{M} that are linear-feedback shift registers. The provisional scramble circuit in the embodiment 1 is equivalent to a case where the number of sub-scramble circuits in a provisional scramble circuit in the embodiment 2 is one.

A predetermined number L of data pieces to be inputted into each of the provisional scramble circuits TS₁ to TSₖ are divided into M subgroups of P data pieces (L=P×M), which are inputted into the M sub-scramble circuits SS₁ to SS_{M}, respectively. As an initial value of a j-th (j is a natural number equal to or more than two and equal to or less than M) sub-scramble circuit SSⱼ of the M sub-scramble circuits SS₁ to SS_{M}, part of output of the (j−1)-th sub-scramble circuit SSⱼ₋₁ is set. Thus, scrambling processing can be performed in a continuous manner. The other configuration is similar to that in the embodiment 1.

Generally, input data is recorded separately in predetermined areas on a memory. Accordingly, processing can be efficiently performed by the processing being performed separately by a plurality of linear-feedback shift registers, for the areas, respectively. Note that the total processing period taken by the provisional scramble circuits TS₁ to TSₖ is not reduced as a result. For example, when input data of L=512 bits is separated into M=8 memory stacks, the separated data (P=64 bits) can be inputted as it is into each of the M sub-scramble circuits SS₁ to SS_{M}, so efficient processing of supplying input and output can be performed.

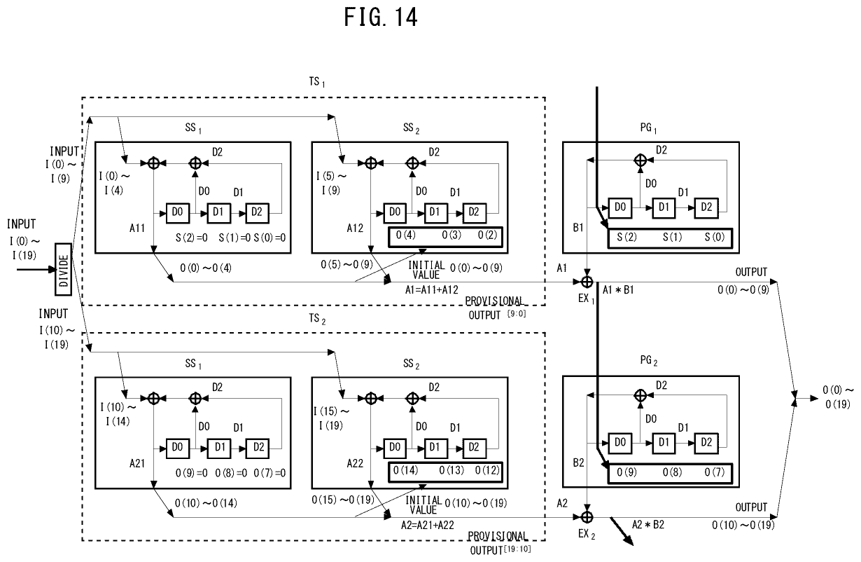

FIG. 14 shows an example in which a three-stage linear-feedback shift register is applied to the sub-scramble circuit in the embodiment 2. A feedback polynomial for the three-stage linear-feedback shift register can be expressed as 1+X+X′. The number of data pieces in one data set is 20, the number k of parallel processes is two, and the number M of sub-scramble circuits included in a provisional scramble circuit is two.

The provisional scramble circuits TS₁, TS₂ process input data pieces I(0) to I(9) and input data pieces I(10) to I(19) in parallel. Each of the provisional scramble circuits TS₁, TS₂ performs processing by using the two sub-scramble circuits SS₁, SS₂ in a sequential manner. Specifically, in the provisional scramble circuit TS₁, the sub-scramble circuit SS₁ performs scrambling processing of I(0) to I(4), and the sub-scramble circuit SS₂ performs scrambling processing of I(5) to I(9). In the provisional scramble circuit TS₂, the sub-scramble circuit SS₁ performs scrambling processing of I(10) to I(14), and the sub-scramble circuit SS₂ performs scrambling processing of I(15) to I(19).

The initial values S(0) to S(2) of the sub-scramble circuit SS₁ in the provisional scramble circuit TS₁ are all zeros, and last data pieces O(4) to O(2) out of the sub-scramble circuit SS₁ are set as the initial values of the sub-scramble circuit SS₂ in the provisional scramble circuit TS₁. For first-time data, all zeros are set as the initial values S(0) to S(2) of the first pattern generation circuit PG₁.

The initial values O(9) to O(7) of the sub-scramble circuit SS₁ in the provisional scramble circuit TS₂ are all zeros, and last data pieces O(14) to O(12) out of the sub-scramble circuit SS₁ are set as the initial values of the sub-scramble circuit SS₂ in the provisional scramble circuit TS₂. As the initial values of the second pattern generation circuit PG₂, last data pieces O(9) to O(7) out of the EXOR circuit EX₁ are set. Thereafter, scrambling processing is similarly performed by 10 data pieces×2 at a time. However, as the initial values of the first pattern generation circuit PG₁, last three data pieces out of the EXOR circuit EX₂ for the previous data set are set.

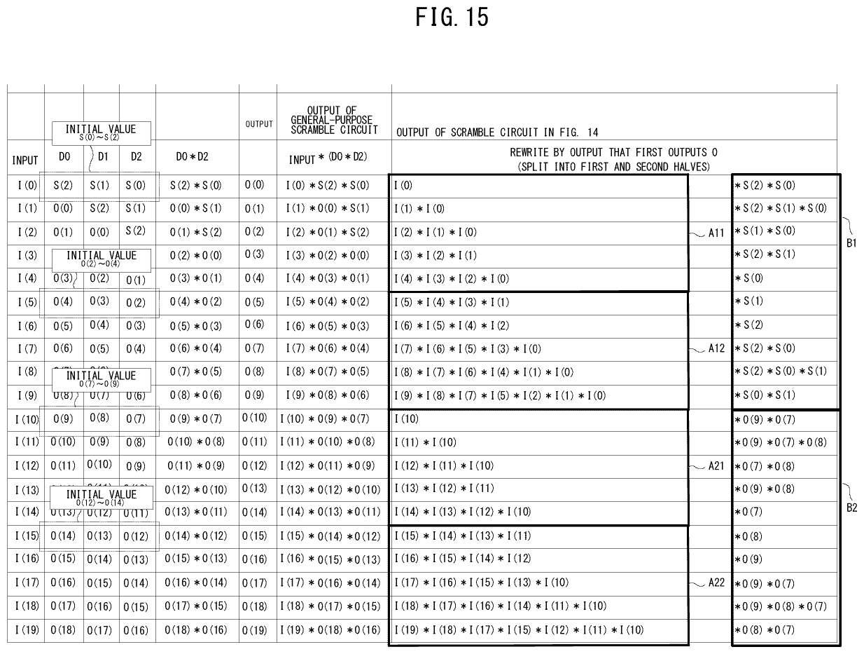

FIG. 15 shows outputs of the scramble circuit in FIG. 14. I(0) to I(9) in the first data set are inputted into the provisional scramble circuit TS₁. The sub-scramble circuit SS₁ of the provisional scramble circuit TS₁ calculates output A11, with the initial values S(0) to S(2)=0. The sub-scramble circuit SS₂ of the provisional scramble circuit TS₁ sets O(2) to O(4) as the initial values and calculates output A12. (A11+A12) is provisional output A1 of the provisional scramble circuit TS₁. The pattern generation circuit PG₁ calculates output B1, with the initial values S(0) to S(2)=0. The EXOR circuit EX₁ calculates an exclusive OR (A1*B1) of the provisional output A1 and the output B1, and outputs O(0) to O(9) are obtained.

I(10) to I(19) in the first data set are inputted into the provisional scramble circuit TS₂. The sub-scramble circuit SS₁ of the provisional scramble circuit TS₂ sets O(7) to O(9)=0 as the initial values and calculates output A21. The sub-scramble circuit SS₂ of the provisional scramble circuit TS₂ sets O(12) to O(14) as the initial values and calculates output A22. (A21+A22) is provisional output A2 of the provisional scramble circuit TS₂. The pattern generation circuit PG₂ sets O(7) to O(9) as the initial values and calculates output B2. The EXOR circuit EX₂ calculates an exclusive OR (A2*B2) of the provisional output A2 and the output B2, and outputs O(10) to O(19) are obtained.

Thus, for input of the first data set of I(0) to I(19), the scrambled outputs O(0) to O(19) are obtained through 2-parallel processing. Although scrambling processing is similarly performed for input of the second data set of I(20) to I(39), O(17) to O(19) are set as the initial values of the pattern generation circuit PG₁.

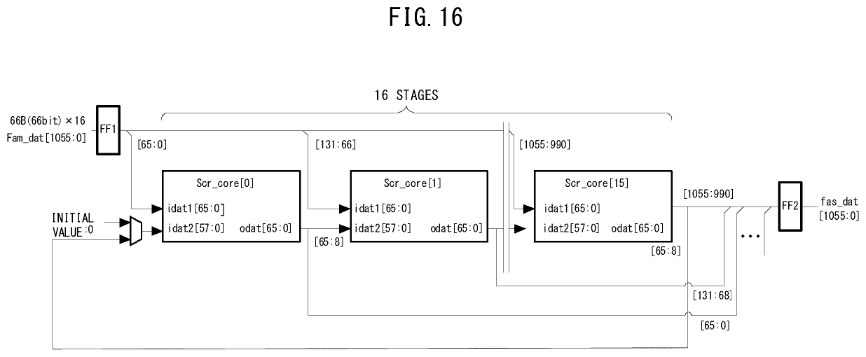

Next, a case where a 58-stage linear-feedback shift register is applied to the sub-scramble circuit in the embodiment 2 is described in comparison with a comparison example. FIG. 16 shows a scramble circuit according to the comparison example. In the comparison example, 16 stages of 58-stage scramble circuits Scr_core[0] to Scr_core[15] are connected between flip-flop circuits FF1, FF2, and serial processing is performed. A feedback polynomial for each scramble circuit can be expressed as 1+x\hat{ }39+x\hat{ }58.

In the comparison example, each scramble circuit receives input data idat1 and initial values idat2 as inputs, and outputs output data odat. In the first cycle, all zeros are set as the initial values of the scramble circuit Scr_core[0]. From the second cycle onwards, output [65:8] of the scramble circuit Scr_core[15] in the previous cycle is set. Of output obtained by a scramble circuit Scr_core[n] (0≤n≤14) performing calculation for 66 bits, s0 to s57 are sets as the initial values of the scramble circuit Scr_core[n+1]. Outputs [65:0], [131:66], . . . , [1055:990] of the scramble circuits Scr_core[0] to Scr_core[15] are inputted into the flip-flop circuit FF1, and [1055:0] is obtained as final output.

In the 16-stage serial processing by the scramble circuit according to the comparison example, there are many logical circuits between the flip-flop circuits FF1, FF2, and timings cannot be satisfied in logic synthesis when input signals come faster (for example, 400 Gbps→800 Gbps).

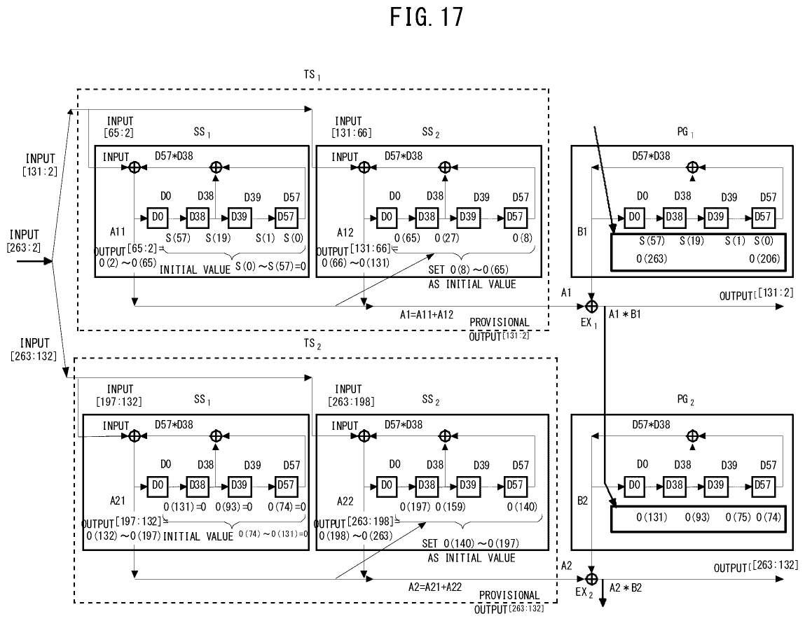

FIG. 17 shows an example in which a 58-stage linear-feedback shift register is applied to the sub-scramble circuit in the embodiment 2. The number of data pieces in one data set is 264 (262 in only the first data set). The number k of parallel processes is two, and the number M of sub-scrambles is two. Of input data pieces I(0) to I(263), I(0) and I(1) are not to be scrambled and are fixed, and scrambling processing is performed on I(2) to I(263).

Last 58 data pieces out of the EXOR circuit EX₂ for the previous data set are set as the initial values of the pattern generation circuit PG₁. However, only for a first-time data set, the initial values of the pattern generation circuit PG₁ are set to all zeros. Outputs 0(74) to 0(131) are set as the initial values of the pattern generation circuit PG₂. Last 58 data pieces out of the EXOR circuit EX₂ are set as the initial values of the pattern generation circuit PG₁ for the next data set.

The provisional scramble circuits TS₁, TS₂ process the input data pieces I(2) to I(131) and the input data pieces I(132) to I(263) in parallel. For the second and following data sets, scrambling processing is similarly performed in two parallel lines by 132 data pieces at a time each. Since the number of stages in serial processing can be reduced by performing scrambling processing in parallel as described above, the period for scrambling processing can be reduced, compared to the comparison example.

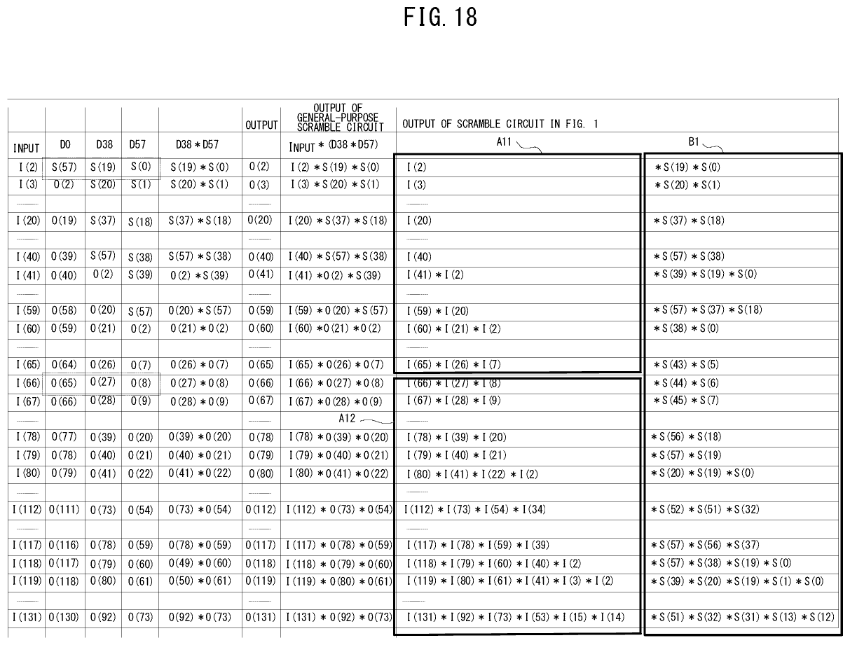

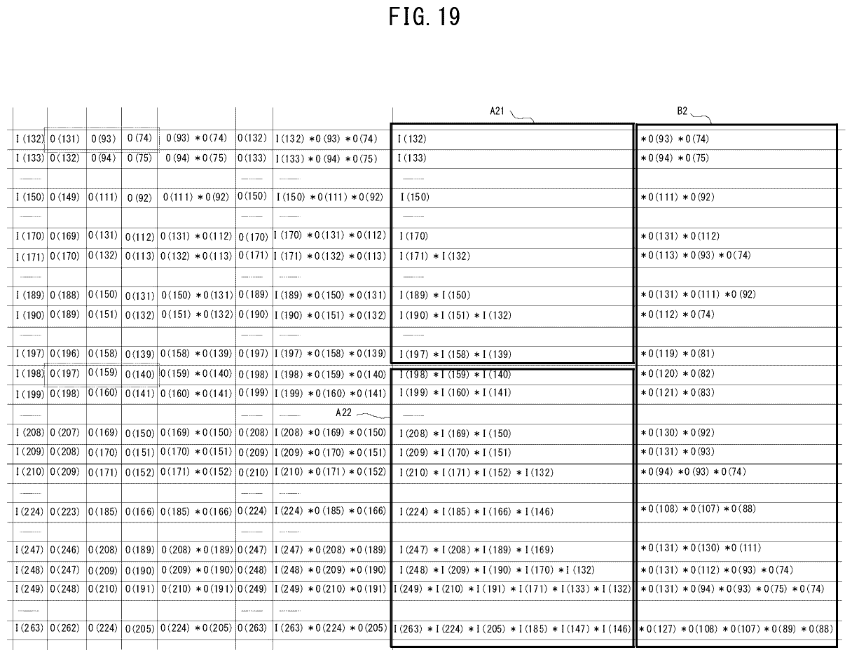

FIGS. 18 and 19 show outputs of the scramble circuit in FIG. 17. I(2) to I(131) in the first data set are inputted into the provisional scramble circuit TS₁. The sub-scramble circuit SS₁ of the provisional scramble circuit TS₁ calculates output A11, with the initial values S(0) to S(57)=0. The sub-scramble circuit SS₂ of the provisional scramble circuit TS₁ sets O(8) to O(65) as the initial values and calculates output A12. (A11+A12) is provisional output A1 of the provisional scramble circuit TS₁. The pattern generation circuit PG₁ calculates output B1, with the initial values S(0) to S(57)=0. The EXOR circuit EX₁ calculates an exclusive OR (A1*B1) of the provisional output A1 and the output B1, and outputs O(2) to O(131) are obtained.

I(132) to I(263) in the first data set are inputted into the provisional scramble circuit TS₂. The sub-scramble circuit SS₁ of the provisional scramble circuit TS₂ sets O(74) to O(131)=0 as the initial values and calculates output A21. The sub-scramble circuit SS₂ of the provisional scramble circuit TS₂ sets O(140) to O(197) as the initial values and calculates output A22. (A21+A22) is provisional output A2 of the provisional scramble circuit TS₂. The pattern generation circuit PG₂ sets O(74) to O(131) as the initial values and calculates output B2. The EXOR circuit EX₂ calculates an exclusive OR (A2*B2) of the provisional output A2 and the output B2, and outputs O(132) to O(263) are obtained.

Thus, for input of the first data set of I(2) to I(263), 2-parallel scrambling processing is performed, and the scrambled outputs O(2) to O(263) are obtained. Although scrambling processing is similarly performed for input of the second data set of I(264) to I(527), O(206) to O(263) are set as the initial values of the pattern generation circuit PG₁.

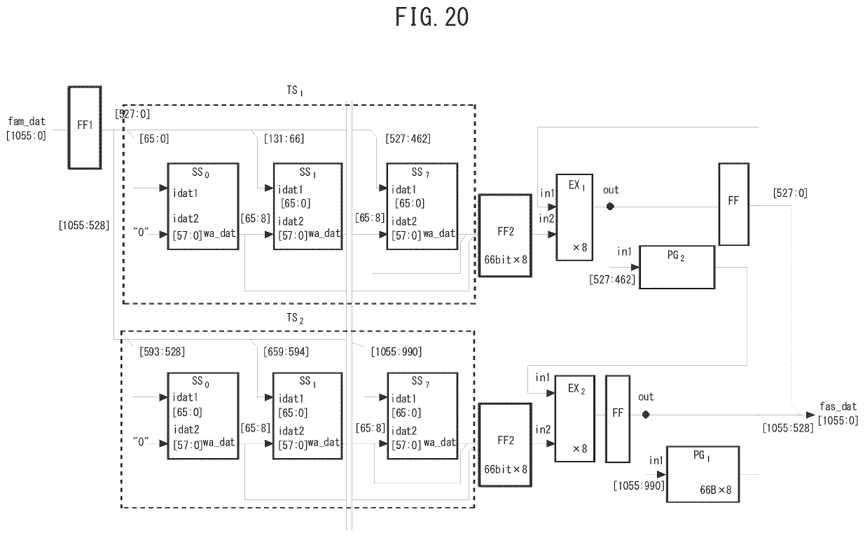

FIG. 20 shows an example in which a 58-stage linear-feedback shift register is applied to the sub-scramble circuit in the embodiment 2, and the number of sub-scramble stages is eight. The number of data pieces in one data set is 1056, the number k of parallel processes is two, and the number M of sub-scrambles is eight. The sub-scramble circuits SS₀ to SS₇ in the provisional scramble circuits TS₁, TS₂ are 58-stage linear-feedback shift registers. The individual sub-scramble circuits receive input data idat1[65:0] as input in parallel, and output output data wa_dat[65:0] in parallel. The initial values idat2 of the first sub-scramble circuit SS₀ are all zeros. As the initial values idat2 of the sub-scramble circuit SS₁, output [57:0] of the sub-scramble circuit SS₀ is set. The pattern generation circuit PG₁ performs pattern generation for 66 B×8 of data in stages after [527:462], which corresponds to 66-B data in the last stage. The pattern generation circuit PG₂ performs pattern generation for 66 B×8 of data in stages before [1055:990], which corresponds to 66-B data in the last stage.

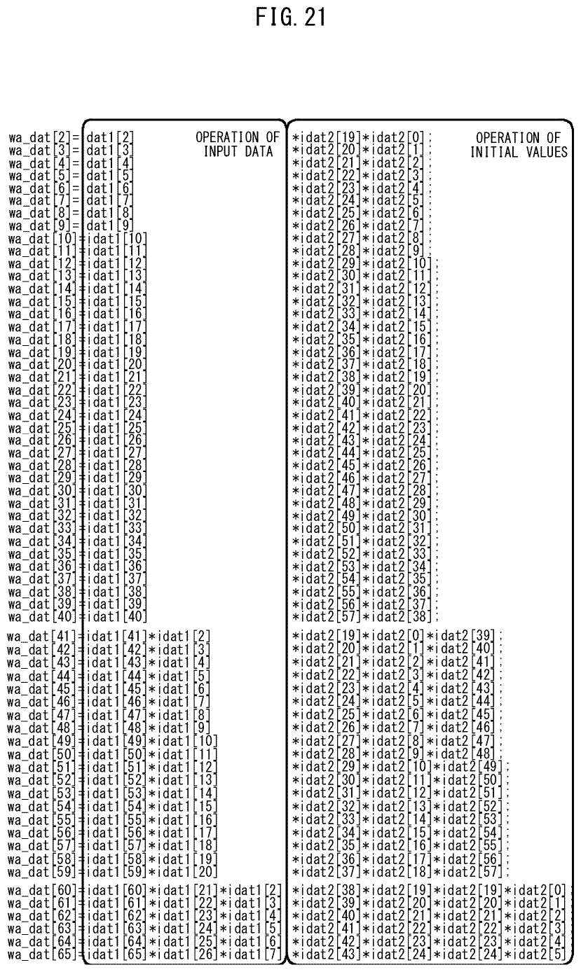

FIG. 21 shows operations performed by the scramble circuit in FIG. 20. The operations are an expansion of a polynomial G(x)=1+x\hat{ }39+x\hat{ }58 with regard to 66-bit parallel data. Since first two bits of the 66 bits is header data, scrambling processing is not performed. Accordingly, bits 0, 1 in output data wa_dat come as wa_dat[0]=idat1[0], wa_dat[1]=idat1[1]. Each of bits 2-65 in output data wa_dat is a result of calculating an exclusive OR of the operation of input data and the operation of initial values as shown in FIG. 21.

The operations of input data in FIG. 21 are performed by the sub-scramble circuits SS₀ to SS₇ of the provisional scramble circuits TS₁, TS₂ in FIG. 20, and the operations of initial values are performed by the pattern generation circuits PG₁, PG₂.

First, the sub-scramble circuits SS₀ to SS₇ of the provisional scramble circuits TS₁, TS₂ perform the operation of input data, with the initial values set to fixed values (here, all zeros). When a result of an operation by the EXOR circuit EX₂ is determined, the pattern generation circuit PG₁ performs the operation and calculates an exclusive OR of a result of the operation thereby and a result of the operation by the provisional scramble circuit TS₁. When a result of an operation by the EXOR circuit EX₁ is determined, the pattern generation circuit PG₂ performs the operation and calculates an exclusive OR of a result of the operation thereby and a result of the operation by the provisional scramble circuit TS₂. Since the provisional scramble circuits TS₁, TS₂ in the preceding stage perform the operations with the initial values set to fixed values, an exclusive OR is calculated for correction thereof with a result of the operations by the pattern generation circuits PG₁, PG₂ in the following stage.

As described hereinabove, in the present embodiment, each of the provisional scramble circuits TS₁ to TSₖ includes a plurality of sub-scramble circuits. Thus, processing can be efficiently performed by processing input data recorded separately in predetermined areas on a memory, for each of the areas. Moreover, since scrambling processing is performed in parallel as in the embodiment 1, the number of stages in serial processing can be reduced. Thus, since the processing period for scrambling can be reduced, it is possible to respond to cases where the data rate increases.

### REFERENCE SIGNS LIST

100 scramble circuit; 200 transmitter; 300 communication channel; 400 receiver; 500 descramble circuit; EX1 to EXk EXOR circuit; FF2 flip-flop circuit; PG1 to PGk pattern generation circuit; TS1 to TSk provisional scramble circuit; SS0 to SSM sub-scramble circuit

1. A scramble circuit continuously scrambling a series of data, the scramble circuit comprising:
k provisional scramble circuits dividing the series of data into groups of L (L is a natural number) data pieces, grouping k (k is a natural number) groups to make one data set of L×k data pieces, performing scrambling processing in k lines in parallel;
k pattern generation circuits generating output data from only initial values without receiving the series of data; and
k EXOR circuits each calculating an exclusive OR of each pair of respective data pieces at same place in order with regard to outputs of the k provisional scramble circuits and outputs of the k pattern generation circuits, and outputting continuous scrambled data for the L×k data pieces,
wherein part of output of the (i−1)-th EXOR circuit is set as an initial value of an i-th (i is a natural number equal to or more than two and equal to or less than k) pattern generation circuit of the k pattern generation circuits.

2. The scramble circuit according to claim 1, wherein each of the k provisional scramble circuits is a linear-feedback shift register,
each of the k pattern generation circuits is a linear-feedback shift register having the same number of stages as the provisional scramble circuit, and
initial values of the k provisional scramble circuits are fixed to all zeros.

3. The scramble circuit according to claim 2, wherein the number of stages in the linear-feedback shift register of the pattern generation circuit is N (N is a natural number), and
N data pieces counting from a last data piece of an output of the (i−1)-th EXOR circuit are set as initial values of the i-th pattern generation circuit.

4. The scramble circuit according to claim 1, wherein for initial values of the first pattern generation circuit, part of output of the k-th provisional scramble circuit for immediately previous data set is set when the data set exists, and all zeros are set when the immediately previous data set does not exist.

5. The scramble circuit according to claim 1, wherein each of the k provisional scramble circuits includes M (M is a natural number) sub-scramble circuits that are linear-feedback shift registers, and
as an initial value of a j-th (j is a natural number equal to or more than two and equal to or less than M) sub-scramble circuit of the M sub-scramble circuits, part of output of the (j−1)-th sub-scramble circuit is set.

6. The scramble circuit according to claim 1, further comprising a flip-flop circuit inserted between the provisional scramble circuit and the EXOR circuit.

7. A communication system comprising:
a scramble circuit continuously scrambling a series of data, the scramble circuit comprising:
k provisional scramble circuits dividing the series of data into groups of L (L is a natural number) data pieces, grouping k (k is a natural number) groups to make one data set of L×k data pieces, performing scrambling processing in k lines in parallel;
k pattern generation circuits generating output data from only initial values without receiving the series of data; and
k EXOR circuits each calculating an exclusive OR of each pair of respective data pieces at same place in order with regard to outputs of the k provisional scramble circuits and outputs of the k pattern generation circuits, and outputting continuous scrambled data for the L×k data pieces,
wherein part of output of the (i−1)-th EXOR circuit is set as an initial value of an i-th (i is a natural number equal to or more than two and equal to or less than k) pattern generation circuit of the k pattern generation circuits;
a transmitter transmitting scrambled data outputted from the scramble circuit to a communication channel;
a receiver receiving the scrambled data from the communication channel; and
a descramble circuit descrambling the scrambled data outputted from the receiver.

8. A scramble method continuously scrambling a series of data, the method comprising:
dividing the series of data into groups of L (L is a natural number) data pieces, grouping k (k is a natural number) groups to make one data set of L×k data pieces, performing scrambling processing in k lines in parallel by k provisional scramble circuits;
calculating an exclusive OR of each pair of respective data pieces at same place in order with regard to outputs of the k provisional scramble circuits and output data generated by k pattern generation circuits from only initial values without receiving the series of data, and outputting continuous scrambled data for the L×k data pieces by each of k EXOR circuits; and
setting part of output of the (i−1)-th EXOR circuit as an initial value of an i-th (i is a natural number equal to or more than two and equal to or less than k) pattern generation circuit of the k pattern generation circuits.
